(19) United States
(12) Patent Application Publication
(10) Pub. No.: US 2002/0126281 A1
(43) Pub. Date: Sep. 12, 2002

(54) Microdensitometer

(76) Inventors: Cheuk Sang Kwok, Kowloon (HK); Kit Yee Lee, Kowloon (HK)

Correspondence Address: LEYDIG VOIT & MAYER, LTD, 700 THIRTEENTH ST. NW, SUITE 300, WASHINGTON, DC, 20005-3960, US

(21) Appl. No.: 09/800,962

(22) Filed: Mar. 8, 2001

(51) Int. Cl. G01J 3/12

(52) U.S. Cl. 356/331

(57) ABSTRACT

A microdensitometer arranged to scan an exposed film is coupled to a programmed computer. The computer analyses images captured through a microscope by a digital camera and to ‘map’ and indicate the optical density of the exposed film and distribution of density levels at any visible wavelength. This information, recorded in the exposed film, can be used to determine the actual exposure to which a patient has been subjected during X-ray treatment, where the film has been exposed to the X-rays during the treatment. If a film is sensitive to mechanical stress, the microdensitometer can also be used to yield mechanical stress distribution that has been applied to the film.

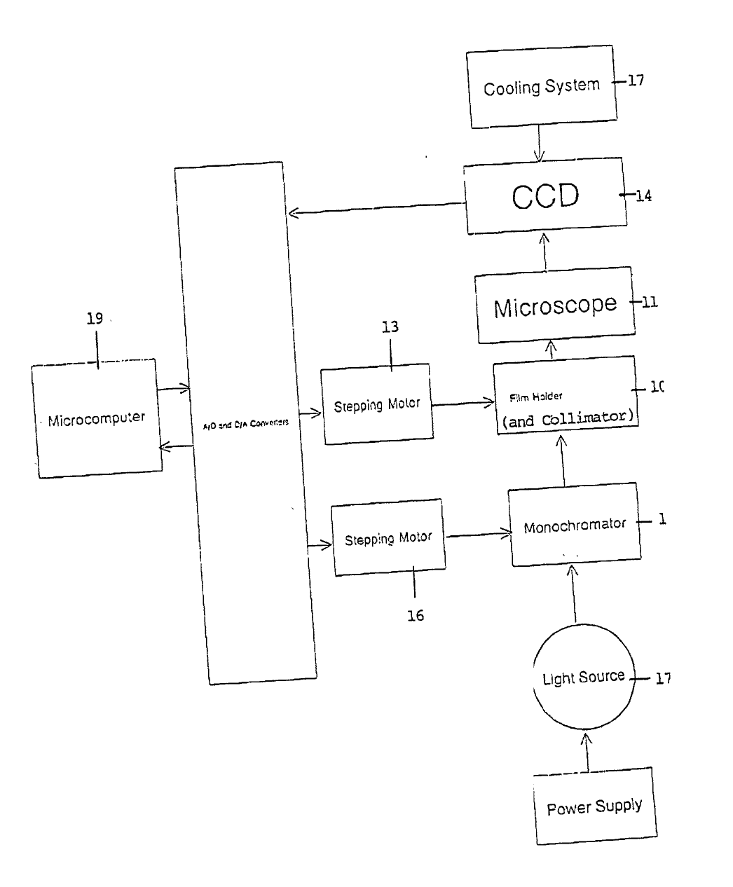

### BACKGROUND OF THE INVENTION

1. Field of the Invention

The invention relates to microdensitometers.

2. Description of the Prior Art

It is known to analyze substances using microscope photometric systems in which images of the substance are captured by a digital camera. The systems may include a monochromator to enable the images to be formed using different wavelengths. The images are normally analyzed using a programmed computer. However, the technology has not been applied to record past events or enable measurements to be made of the exposure of radiation or mechanical stress to which persons or structures have been subjected.

### SUMMARY OF THE INVENTION

It is an object of the invention to overcome this problem.

According to the invention there is provided a scanning spectral microdensitometer for use in measuring optical density of an exposed film, including a film holder, a microscope, a stepping motor arranged to move the film holder across a plane in a field of view of the microscope, a digital camera arranged to capture images of the different regions of the film through the microscope, and a microcomputer programmed to compute the optical density of each image and to control the operation of the stepping motor and the digital camera.

The film holder is preferably arranged to be moved by the scanning motor in at least two directions at right angles to one another.

A monochromator may be mounted between a light source and the film holder, and a second stepping motor coupled to the monochromator and arranged to be controlled by the computer.

A forced air thermoelectric cooling system may be provided to cool the digital camera.

### BRIEF DESCRIPTION OF THE DRAWINGS

A scanning spectral microdensitometer according to the invention will now be described by way of example with reference to the accompanying drawing which shows a block diagram of the microdensitometer.

### DESCRIPTION OF THE PREFERRED EMBODIMENTS

Referring to the drawing, the microdensitometer is made up, generally stated, of components that are already per se known. A conventional film holder 10 (associated with a collimator) for an exposed film is mounted to be moved in a plane across a field of view of a microscope 11 by a stepping motor 13. The stepping motor 13 can move the film holder 10 in two directions perpendicularly the microscope to enable the exposed film to be scanned and a plurality of 2D images to be captured by a digital camera 14. A monochromator 15 that is controlled by a second stepping motor 16 is positioned between a light source 17 and the film holder 10. The stepping motor 16 is used to adjust the monochromator to alter the wavelength of light directed through the exposed film. A forced air thermoelectric cooling system 17 is provided to maintain the camera at around 37° C.

A microcomputer 19 is programmed to control the stepping motors 13 and 16 and operation of the camera 14, as well as compute the optical density of each recorded image of the film. The computer may be arranged to generate an optical density ‘map’ showing the distribution and optical densities of the whole film (frame) held in the film holder and collimator 10 after a full 2D scanning cycle.

The described microdensitometer is used for ‘mapping’ the optical density of an exposed film which is provided as a record of a past event. In a typical application, the film is X-ray sensitive and provides a record of the exposure of a patient to radiation for treating cancer sites. The film is positioned during the X-ray treatment on the patient in the region of X-ray radiation and is exposed by the X-rays to record the entrance or exit dose of X-rays. Alternatively, the film can be positioned in a phantom simulating a patient in order to measure the dose distribution inside a patient.

Optical density (OD) is calculated according to an established relationship:—

OD=K.log(Iin/Io)

where K is a constant, Iₒ is intensity of light exiting the film, and Iᵢₙ is the intensity of light impinging on the film from the light source 17. The computer is therefore able to compute the actual radiation to which the patient has been exposed to and the distribution of that exposure. Normally, it is imperative not only to control the maximum exposure but to confine the exposure to a very small area for satisfactory and safe treatment. Hitherto, such treatment has been very difficult to measure and record.

The microdensitometer can also serve to calibrate and spatially assess a X-ray radiation source output by simply exposing ‘test’ films in the absence of a patient. In practice, the microdensitometer can be pre-calibrated for each make or type of film used. Alternatively or additionally part of the film can be blocked during radiation treatment so that when that screened part is scanned, a background value is automatically provided by a captured image of the blocked off part of the film.

The monochromator is used to enable improvements in sensitivity by altering the wavelengths used for scanning different kinds of film, according to their preferred spectral responses.

Films are now available that change color according to applied mechanical stresses. Thus, such a film can be placed between two structural surfaces that are normally pressed together, or in any kind of bolted jointed or clamp, for example. In such cases, the film responds to the mechanical stress and becomes strained, in effect, to record the stresses that have been applied. Such a film is also referred to herein as an ‘exposed film’ because its characteristics (color or optical density) as recorded is analogous to that of an exposed light sensitive film. The described microdensitometer can be used with such an ‘exposed film’ to determine the degree and distribution of mechanical stresses that have been applied to the film. Thus, optical density results provided by the microdensitometer can be used to analyze and generate a ‘map’, if required, of mechanical forces that have been applied to a structure. Such measurements may be used for analyzing the structures, recording applied mechanical stresses and so forth. In one typical application, a film is positioned under the sole of a foot inside a shoe. The film then ‘records’ the amount of pressure and its distribution when a person walks wearing the shoe, so as to check, using the microdensitometer, the person's walking posture or possibly sign of lameness due to an injury for example.

We claim:

1. A scanning spectral microdensitometer for use in measuring optical density of an exposed film, including a film holder, a microscope, a stepping motor arranged to move the film holder across a plane in a field of view of the microscope, a digital camera arranged to capture images of the different regions of the film through the microscope, and a microcomputer programmed to compute the optical density of each image and to control the operation of the stepping motor and the digital camera.

2. A scanning spectral microdensitometer according to claim 1, in which the film holder is arranged to be moved by the scanning motor in at least two directions at right angles to one another.

3. A scanning spectral microdensitometer according to claim 1, including a monochromator mounted between a light source and the film holder, and a second stepping motor coupled to the monochromator and arranged to be controlled by the computer.

4. A scanning spectral microdensitometer according to claim 1, including a forced air thermoelectric cooling system provided to cool the digital camera.
